(19) United States
(12) Patent Application Publication
(10) Pub. No.: US 2015/0274420 A1
(43) Pub. Date: Oct. 1, 2015

(54) APPARATUS AND METHOD FOR QUICKLY TRANSFERRING PLATES

(71) Applicant: GRENZEBACH MASCHINENBAU GMBH, Asbach-Baeumenheim (DE)

(72) Inventor: Franz Krommer, Mertingen (DE)

(73) Assignee: GRENZEBACH MASCHINENBAU GMBH, Asbach-Baeumenheim (DE)

(21) Appl. No.: 14/435,009

(22) PCT Filed: Oct. 1, 2013
(86) PCT No.: PCT/DE2013/000564

§ 371 Date: Apr. 10, 2015

(30) Foreign Application Priority Data
Oct. 22, 2012 (DE) 10 2012 020 679.8

(51) Int. Cl. B65G 1/04; B65G 65/00; B65G 65/02; B65G 39/00

(52) U.S. Cl. CPC B65G 1/0464; B65G 39/00; B65G 65/005; B65G 65/02; B65G 2203/0233; B65G 2203/042

(57) ABSTRACT

Disclosed are an apparatus and a method for quickly transferring plates, in particular glass plates, of different sizes, thicknesses and quality levels so as to place the plates one behind another on different stacking frames, said apparatus and method having the following features: a) the plate (5) that is to be transferred on conveyor rolls of a transport device (7) is gripped by a gripping device (4) and the rotatable gripping fingers (13) thereof that are provided with holding means (14), the gripping device (4) being suspended on support cables (2); b) the gripping device (4), together with the plate (5), is then conveyed to a selected stacking frame (6) by shortening and/or lengthening appropriate support cables (2) and is deposited on the stacking frame (6) by releasing the holding means (14); c) the gripping device (4) is conveyed to the next operating position thereof by shortening and/or lengthening specific support cables (2).

### CROSS-REFERENCE TO RELATED APPLICATION

This application is a U.S. national phase of International Application No. PCT/DE2013/000564 filed Oct. 1, 2013, and claims priority of German Patent Application No. 10 2012 020 679.8 filed Oct. 22, 2012, both of which are incorporated herein by reference in their entireties.

### BACKGROUND OF THE INVENTION

1. Field of the Invention

The invention relates to transferring plates quickly, in particular glass plates.

2. Description of the Prior Art

Large-area glass plates are produced in the form of float glass as a result of continuously pouring molten glass on a tin bath that is heated in an elongated tub and the glass ribbon resulting herefrom. Said glass ribbon comprises one side which lays on the tin bath, the so-called bath side. The other side of the glass ribbon which has been cooled in the air is designated as the so-called airside. The bath side and the airside comprise different characteristics. As, for example, the airside comprises fewer irregularities, it is better suited for coatings. The subsequent preparation of the float glass occurs as a result of longitudinally cutting and cross cutting the glass ribbon which emerges at a certain feed rate from the float glass production. Longitudinal cutting wheels that are non-movably installed in a corresponding position above the glass ribbon bring about the longitudinal cutting in this connection and the cross cutting is effected by means of cutting bridges and cross cutting wheels that are moved transversely thereon over the glass ribbon. Glass plates of considerable size are able to be produced in this way. A size of 6 meters by 3.21 meters is designated as the so-called large size or jumbo format in this connection. A plate size of 3.21 meters by 2 meters (up to 2.5 meters) is designated as the so-called split size or medium format.

In order to convey glass plates of such sizes from one place to another without breakage, to this end holding mechanisms, in the majority of cases in the form of a sturdy frame, are moved to the relevant glass plate, connected to it by means of suction cups and then the holding mechanism with the glass plate suctioned thereon is conveyed further.

From the prior art, DE 197 12 368 A1 makes known a method for transferring objects from a first point to a second point using a holding mechanism that binds the object to it during the transferring process, where the object that is to be achieved is to develop said method further in such a manner that it is possible to transfer objects reliably under all circumstances in a simple manner. In this case, glass panes are named as the objects to be transferred. Said object is achieved, according to the information in part of the claims, in that the lifting mechanism approaches the object to be transferred to the first or the second point by taking the actual position and/or alignment of the same into consideration, the holding mechanism being aligned where necessary by utilizing free rotatability and/or pivotability of the same about one or several axes.

Further, at least one of the claims explains in more detail that the object to be transferred is a glass pane, that the first point is an inside loader rack and that the second point is a conveyor belt and the holding mechanism is a suction frame.

DE 101 48 038 A1 describes an apparatus for transferring plates from a plate conveyor to a stacking rack or the like, with a robot with a robot arm which carries on its free end a suction frame or the like for receiving a plate from the plate conveyor, and which is provided with a number of degrees of freedom sufficient for its movement function.

The object underlying the further development of such an apparatus is to realize an apparatus for transferring plates from a plate conveyor to a stacking rack such that, in the event of a glass plate, impairment of the airside of the glass is prevented as much as possible.

Said object is achieved in that the plate conveyor is provided with a recess into which the robot arm is able to enter, and with recesses which also enable the entry of the suction frame or the like. In addition, the suction frame or the like is to be arranged on the free end of the robot arm so as to be pivotable into an upwardly pointing position in order to grip a plate on its side that faces the plate conveyor from the position inserted into the recesses of the plate conveyor.

The stacking rack used here is fastened non-movably to the floor, consequently it can only be loaded from the side that faces the robot arm. In addition, the stacking rack has to be moved away from the robot arm by the slight distance of the thickness of a glass plate in each case when loading with a further glass plate as the distance of the robot arm provides a fixed variable. So-called clock carriages, which, in each case prior to loading with a new glass plate, move the stacking rack away from the robot arm by the distance of a glass plate thickness, are necessary for this purpose in practice in the prior art in order to make space for a further glass plate. In addition, a turntable is necessary for loading the stacking rack from the other side. For loading the stacking rack with large and heavy glass plates, the required clock carriages and the turntable necessary according to the load occurring are designed in an expensive manner and are very costly to produce.

Using the apparatuses from the prior art, however, it is not possible in one facility and in the same operating cycle to distribute glass plates of different formats, different thicknesses or different quality levels to different stacking racks set up to this effect. In particular, so-called A racks which allow for stacking from both sides, cannot be loaded by robots in this connection.

### SUMMARY OF THE INVENTION

The object underlying the apparatus according to the invention or the corresponding method is consequently, with glass plates of the most varied formats, thickness or quality levels, to capture them in the shortest time on the production line, to receive them in a vibration-free manner and to stack them reliably on different stacking racks, even so-called A racks which can be loaded from both sides. At the same time, the corresponding apparatus is to be cost-efficient. As a glass plate also has to be coated sometimes and such a coating is to be applied in the majority of cases on the smooth side, namely the airside, it is necessary also to be able to capture such a glass plate from the opposite side, namely the bath side.

Said object is achieved with a special arrangement of cable mechanisms with the features and methods according to the claims.

### BRIEF DESCRIPTION OF THE DRAWINGS

The invention is described in more detail below by way of the figures, in which, in detail:

FIG. 1: shows a perspective representation of the overall apparatus;

FIG. 2: shows a sectional drawing through the overall apparatus;

FIG. 3: shows a sectional drawing through the overall apparatus in movement;

FIG. 4: shows a sectional drawing of the operating sequence (bottom surface);

FIG. 5: shows a section of the step following FIG. 4;

FIG. 6: shows the step following the movement operation of FIG. 5;

FIG. 7: shows a top view of the gripping device;

FIG. 8: shows a top view of an alignment unit for a plate 5;

FIG. 9: shows a representation of an electrostatic gripper element;

FIG. 10: shows a section through a power suction device; and

FIG. 11: shows a section through a precision suction device.

### DETAILED DESCRIPTION OF THE PREFERRED EMBODIMENT

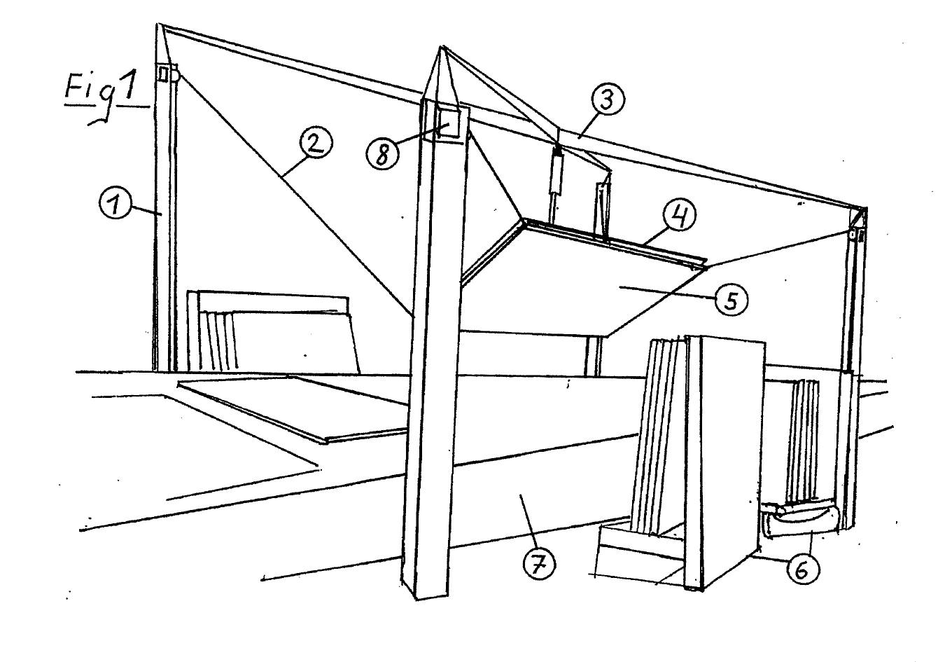

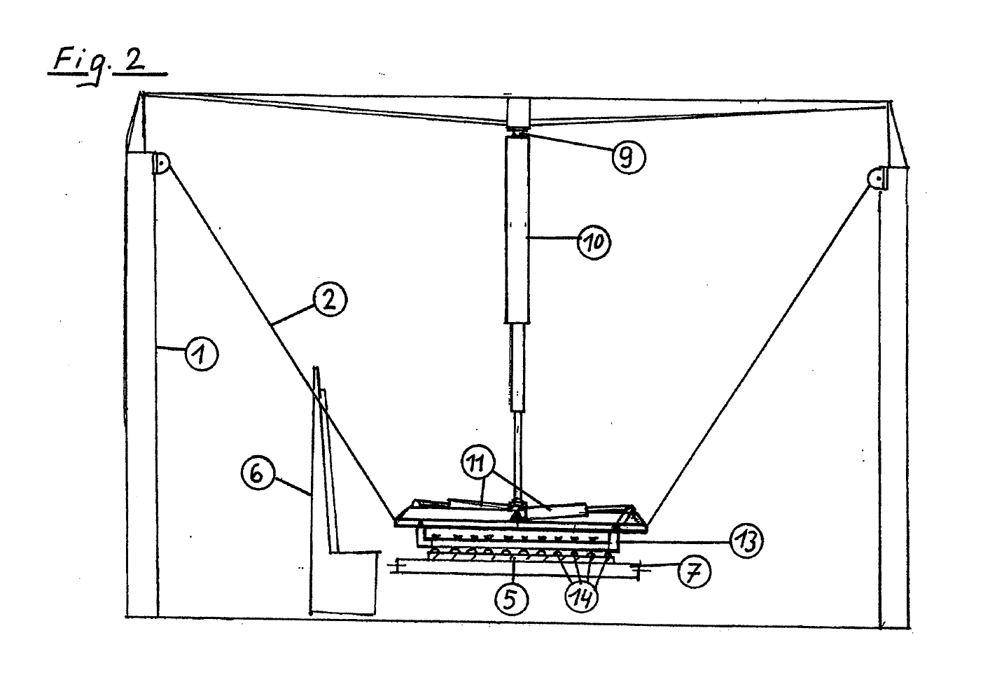

FIG. 1 shows a perspective representation of the overall apparatus. The essential difference to conventional apparatuses for transferring or conveying plates, in particular glass plates, is that the gripping device for capturing the plates is not moved by means of robot-based structures, but by means of a special cable mechanism. Said cable mechanism consists substantially of four crane posts 1 which surround in a spacious manner the region that is required for transferring the plates. Said crane posts can be inclined in the direction of the required zone in order to ensure unimpeded operation for the transferring operation. FIG. 1 shows a characteristic position of a gripping device 4 with a plate 5 that it has captured. In this connection, the gripping device 4 is held by four support cables 2, the length of which is modified in a synchronous manner in each case by means of a cable drive 8 at the tip of the crane posts 1. To stabilize the crane posts 1 and the movement operation of the gripping device 4, the four crane posts 1 are mechanically connected by a diagonal supporting cross 3. At the same time, the diagonal supporting cross 3 serves as the bearing arrangement of the stabilizing means 10, as can be seen clearer in FIG. 2. In addition, two stacking racks 6 are designated on the right-hand side in FIG. 1, opposite which on the other side of a conveying device 7 is an unmarked stacking rack. Two horizontal plates can be seen on the conveying device 7, which is sketched here as a belt-like structure. The plates 5 which arrive on the conveying device 7 can differ in format, in their thickness or in their quality level.

FIG. 2 is a sectional drawing through the overall apparatus. In this case, a vertically positioned crane mast or post 1 is shown in each case on the left-hand side and on the right-hand side, both of which are connected by means of the diagonal supporting cross which is visible in the section and is not additionally marked. A stabilizing means suspending means 9 and the stabilizing means 10 already mentioned in FIG. 1 for the gripping device 4 are shown in the center of the diagonal supporting cross. The stabilizing means 10 is mounted on the one hand in the stabilizing means suspending means 9 so as to be flexible all around and on the other hand so as to be shortened or lengthened in a telescopic-like manner. The stabilizing means 10 is also mounted so as to be flexible all around in the central region of the gripping device and serves for stabilizing the gripping device 4 which is arranged in a suspended manner between the support cables 2. In said representation it is only possible to see two oppositely situated support cables 2 out of the four support cables. In the bottom part in the center of FIG. 2, the conveying device 7 with a horizontal plate 5 that is to be transferred is shown in section. Its rollers can be driven individually and are height-adjustable. The gripping device shown in FIG. 2 comprises on both sides in the edge region gripper fingers 13 which are flexibly mounted so as to be folded up or down by means of pivot joints. The gripper fingers 13 are hinged alternately to the left and right. The operation of folding up or down the gripper fingers 13 is brought about by drives 11. The gripper fingers 13 have holding means 14 which are arranged on both sides as, as will be shown subsequently, they are able to capture the plates to be transferred from the top surface or the bottom surface.

The gripper fingers 13 are arranged in the gripping device 4 such that they are able to reach through between the spaces between the rollers of the conveying device. The supplying of the electric power required for the gripping device (4) and for the control signals required for controlling the gripping device (4) is effected by means of the support cables (2). The transmission of electric power and of a plurality of required control signals is ensured by means of an allocation to different transmission frequencies. The electric power supplied in this way serves for the operation of the drive 11, of a vacuum pump (not shown) for operating the holding means 14 and for the operation of sensors for detecting the position of the gripping device.

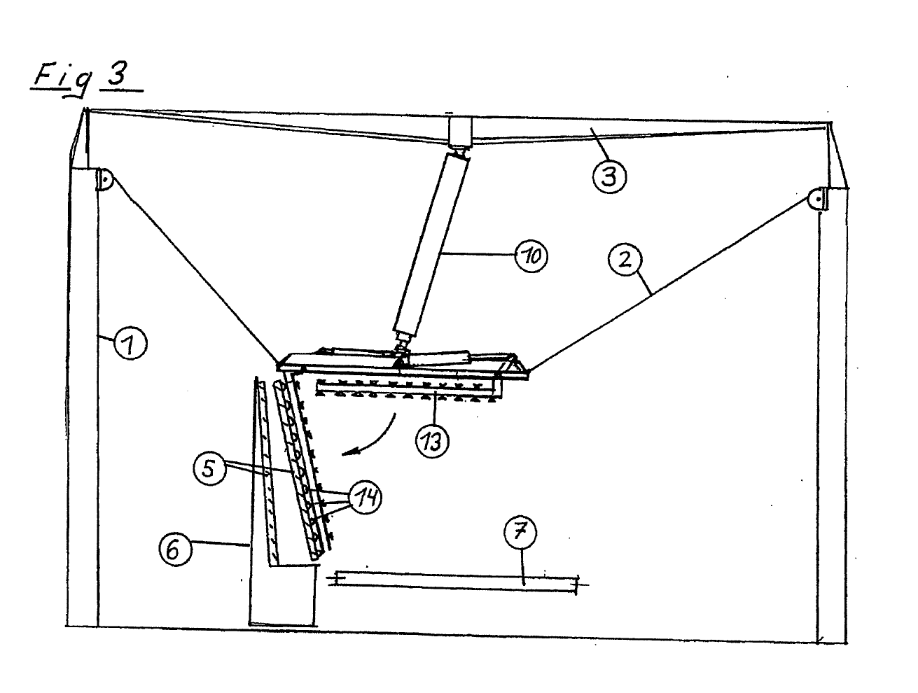

FIG. 3 shows a sectional drawing through the overall apparatus in movement. As is described in the description of FIG. 2, it can be seen here that the part of the gripping fingers 13 hinged to the left has captured a plate 5 with its holding means 14 and is about to deposit said plate on the stacking rack 6 that is positioned to the left, on which one other plate 5 is already located. It can clearly be seen here that the gripping fingers 13 carry holding means 14 on the two longitudinal sides. In the event of a glass plate 5, this would be a turning operation which would have been brought about by access on the airside. The stabilizing means 10, in said representation, is shortened corresponding to the modified length of the support cables 2. The position of the crane posts 1, of the diagonal supporting cross 3 and of the conveying service 7 are unchanged in relation to the conditions in FIG. 2.

A corresponding stacking rack 6 is shown on the left-hand side of FIG. 3. It can be seen that it is possible with the apparatus shown also to position a plate 5 on the other side of the stacking rack 6 shown. If the plate to be transferred were to be deposited on a stacking rack 6 that is positioned on the right, the gripping fingers 13 hinged to the right and the cable drives 8 would become active in a corresponding manner and deposit the corresponding plate 5 on a stacking rack positioned to the right.

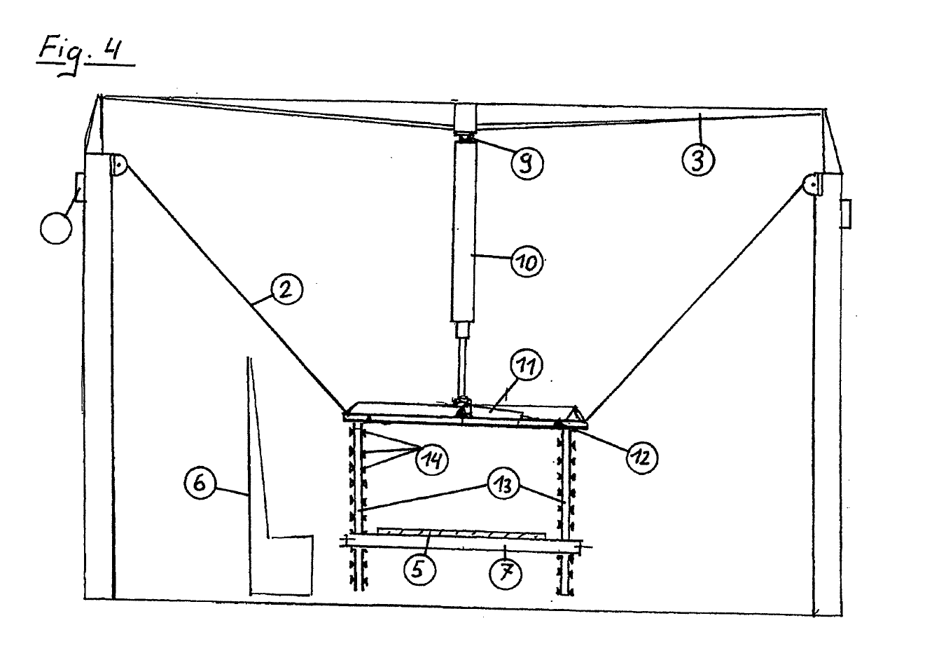

FIG. 4 shows a sectional drawing of the operating sequence when transferring a plate with access from the bottom surface, that is from the side on which the corresponding plate rests on the conveying device 7. In the event of a glass plate 5, this would be a turning operation that would have been brought about by access on the bath side. The position of the crane posts 1, of the diagonal supporting cross 3 and of the conveying device 7 with a plate 5 resting thereon are unchanged in relation to the conditions in FIG. 2. The cable drives 8 are shown separately in this case. The length of the support cables 2 and the position of the stabilizing means 10 and of its suspending means 9 fix the gripping device 4 in this respect at a height that enables the gripper fingers 13 that are hinged to the left and right to be folded out in their pivot joints 12 and the gripper fingers 13 to be extended in the vertical position. It can also clearly be seen in said view that the gripper fingers 13 carry holding means 14 on the two longitudinal sides. The drives 11 for folding out the gripper fingers 13 are, corresponding to the position shown, in a central position of extension. The stacking rack 6 that is to be loaded is situated on the left-hand side in the figure. It is provided in a particular expansion stage that the length of the gripper fingers 13 can be shortened in a telescopic-like manner for reasons of space, it being taken into consideration that the holding means 14 are also moved closer together in a telescopic-like manner in this region. A shortening by approximately one third of the total length to almost the entire length of a gripper finger 13 can be realized in this connection. At the same time, it is remarked at this point that the height of the conveying device 7 is to be modified in an adjustable manner in adaptation to different plate formats.

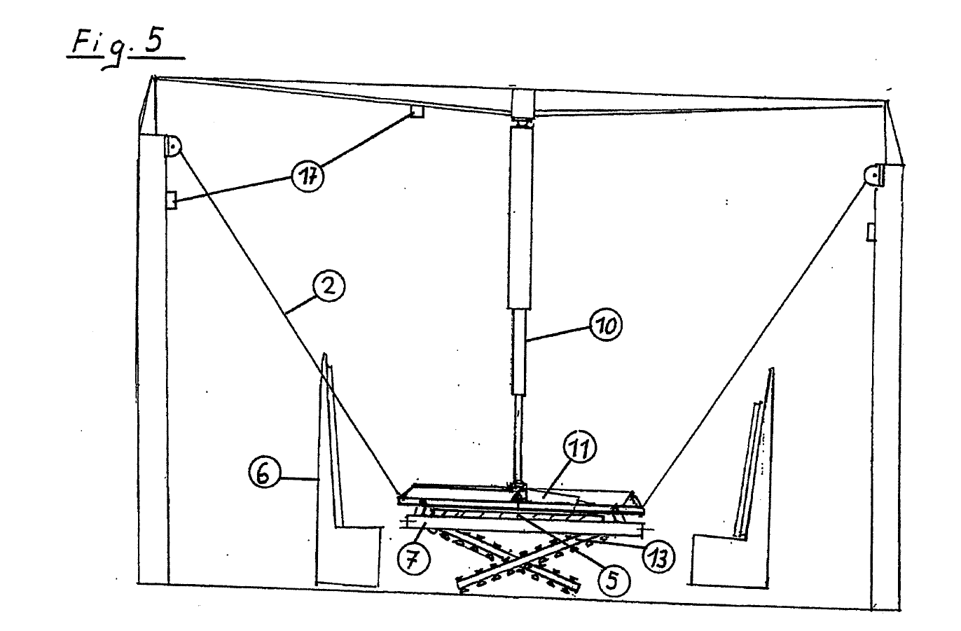

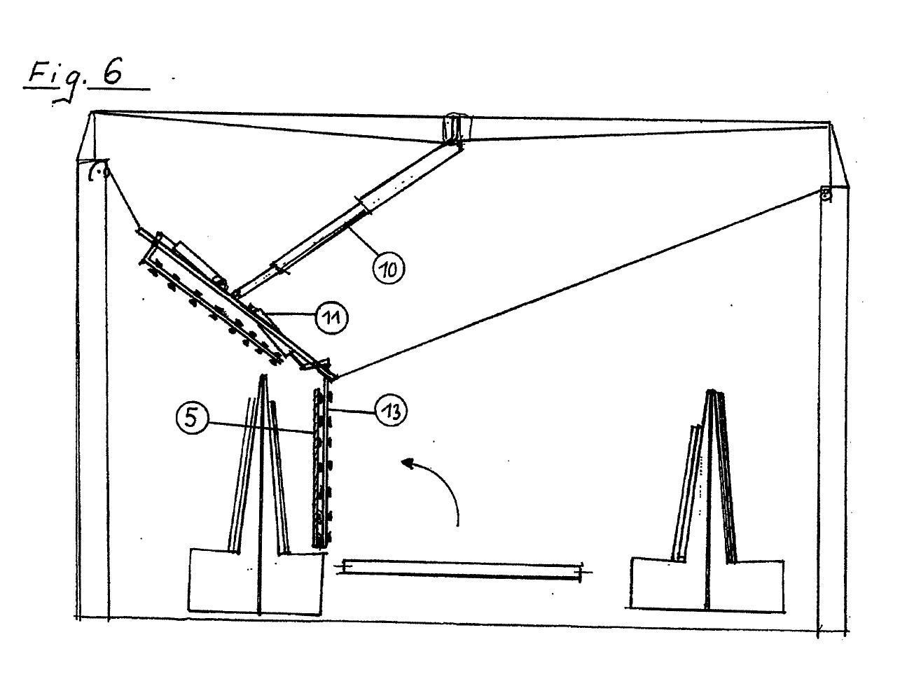

FIG. 5 shows a section of the step following FIG. 4. The conditions correspond substantially to those shown in FIG. 4. The difference is that in said representation the gripper fingers 13 are more angled in their pivot joints and are about to capture the plate 5 from the bottom surface. The stabilizing means 10 is further extended in its length corresponding to the modified positioning shown of the gripper fingers 13. Since, as can be seen from the representation of subsequent FIG. 6, the intention is to deposit the plate 5 on the left-hand stacking rack 6, just the holding means 14 of the gripper fingers 13 that are hinged to the right are activated such that the plate 5 can be deposited on the left-hand stacking rack with the side that is resting on the conveying device 7 upward. It is pointed again once again here that for easier movement in the pivot joints 12 the gripper fingers (13) are able to be shortened in a telescopic-like manner in the last third of their total length.

For monitoring the entire turning operation, light field sensors 17 are shown in the top left-hand region of the relevant crane mast and of the diagonal supporting cross. The number of said sensors depends on the size of the apparatus according to the invention. The light field sensors 17 can be used to supplement usual laser sensors.

With regard to said light field sensors 17, reference is made to the new development of the so-called mini-lenses which, in the form of hundreds of mini-lenses, collect optical data according to the light field principle which can then subsequently be assembled using data technology to form images with a desired resolution and/or a desired perspective. Such mini-lenses are 3D-capable, cheap to produce and follow the principle of an insect eye. They are capable of contributing to the higher-ranking data-processing coordination of the localization means and holding means involved.

FIG. 6 shows the step following the movement operation in FIG. 5. The support cables on the left-hand side of the transferring apparatus according to the invention are shortened in such a manner and the stabilizing means 10 is pivoted so far to the left that the gripper fingers 13 of the gripping device with the plate 5 pass into the region of the left-hand stacking rack. Further coordinated shortening of the left-hand support cables in conjunction with corresponding lengthening of the right-hand support cables and a possibly necessary slight correction of the position of the gripper fingers 13 by means of their drive 11 complete the transferring operation. Consequently, the holding means 14 are then released from the plate 5 and the gripping device is moved into a further operating position. By means of the apparatus according to the invention, it is also possible to operate so-called A racks which provide a loading possibility on two opposite sides, as if the crane posts 1 are correspondingly dimensioned the vertical operating region is easy to widen. Two A racks are consequently shown on the left-hand side and the right-hand side in FIG. 6. Reference has already been made to said possibility in the description regarding FIG. 3.

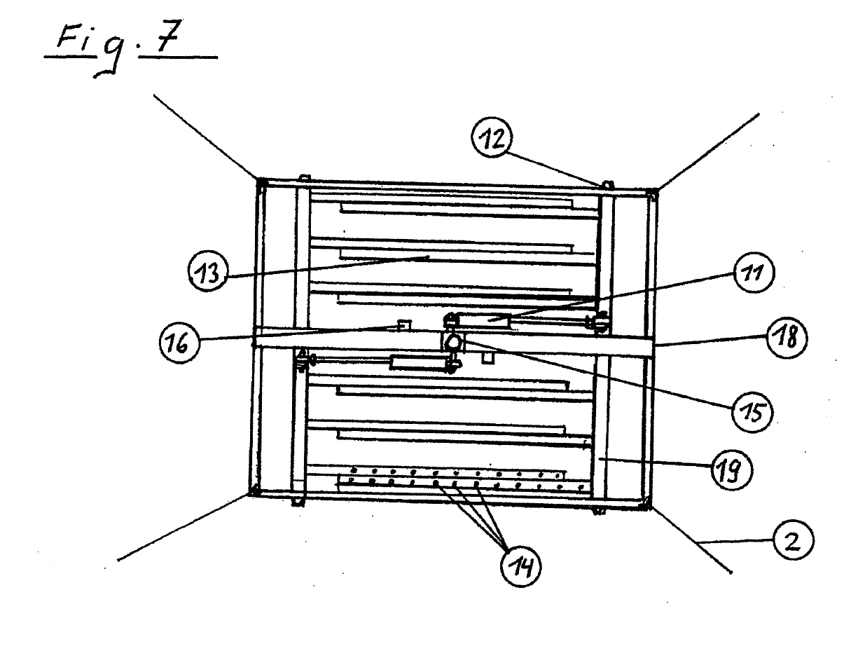

FIG. 7 shows a top view of the gripping device. The rectangular gripping device with the support cables 2 that are fastened at its four corners can be seen from above in this case. The mounting 15 of the entire frame for the stabilizing means 10, which is held by the four support cables 2, is arranged in the center of the gripping device. The pivot joints 12 for the gripper fingers 13 that are hinged to the right or the left with their respective holding means 14 that are only shown in the case of the bottom gripper fingers, can be seen on the right-hand and the left-hand side. The associated drive 11 is shown for the gripper fingers 13 that are hinged to the right. At least one sensor 16, which in this case is shown as an example in the central region of the gripping device, serves for capturing the position and for controlling the gripping device. Depending in each case on the size of the overall facility, laser sensors and/or light field sensors 17 can be used additionally in this case too.

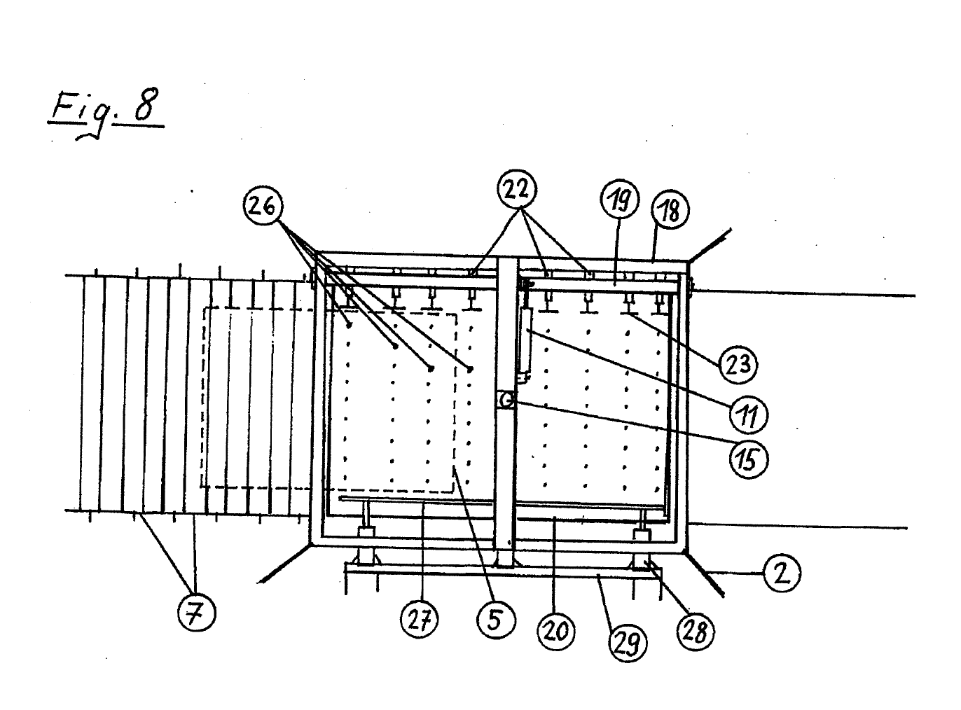

FIG. 8 shows a top view of an alignment unit for a plate 5 in conjunction with electrostatic gripper elements 20. Said type of gripper elements require a particular development of the gripping device in the region of the gripper fingers 13. On the left-hand side of said figure, the conveying device 7 is shown as an example as a roller conveyor with a plate 5 coming in. After leaving the conveying device 7, the plate 5 passes in this case into a region of the gripper frame 18 which is suspended by the four support cables 2, is connected to the stabilizing means by means of the frame mounting 15 and allows it to hover on air nozzles 26 and consequently enables a precise alignment of its position on the air cushion that is generated in this manner. The alignment strips 27 that can be seen in the bottom region of the figure and can be moved in a substantially horizontal manner to the left and the right in each case by means of a synchronous drive 28 which is fastened on a holding device 29 serve this purpose.

The position of an electrostatic gripper element 20 is indicated in said region.

Eight alignment devices 22 with alignment plates 23 along the longitudinal side of said frame are provided on the opposite side of the gripper frame 18. Said alignment devices are individually actuatable and can be individually activated and enable precise positioning of the respective plate 5 in conjunction with the alignment strip 27.

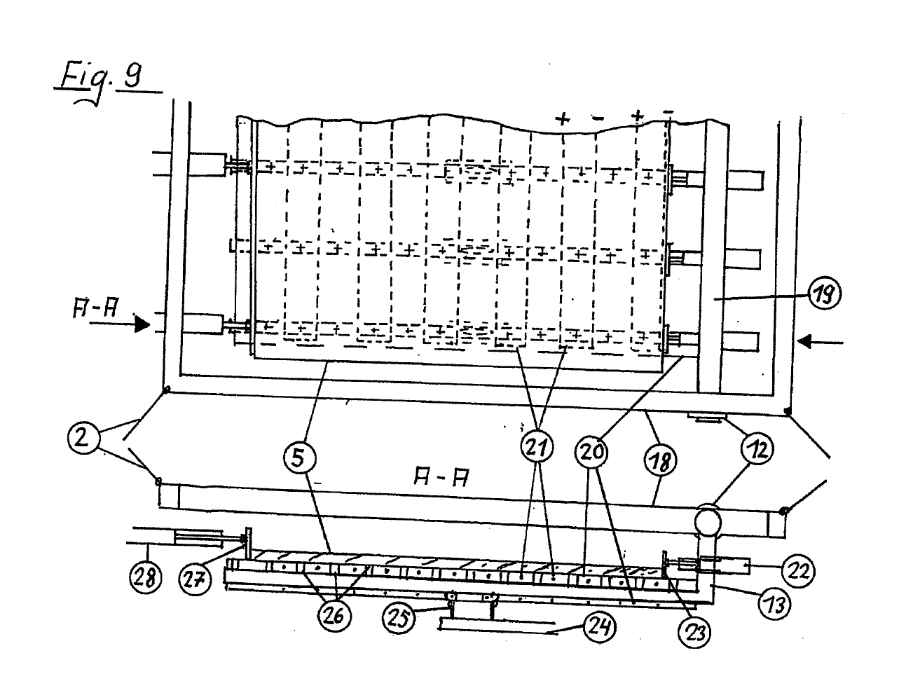

The gripper finger carrier 19 with the drive 11 for the corresponding gripper fingers can also be seen in the representation shown. More details in this regard can be found in FIG. 9.

FIG. 9 shows a representation of an electrostatic gripper element. An extensive enlargement of a detail in the region of a gripper finger carrier 19 with a plate 5 lying thereon is shown in the top region of the figure and a line of intersection A-A has been marked thereon. As an example, faces 21 have been marked here, the different tension levels of which bring about electrostatically induced adhesion of the plate 5 to the air cushion that is generated by means of the air nozzles 26.

A side view in the region of the line of intersection A-A shows in the bottom region of the figure next to the gripper frame 18 and the pivot joint 12 of the relevant gripper finger 13 the alignment strip 27 with the synchronous drive 28 on the one side and the alignment device 22 with an alignment plate 23 on the other side. The compressed air supply 24 with the corresponding coupling device 25 can be seen in the bottom region of the figure.

Such electrostatic grippers are the prior art and can transfer forces of up to 20 N/cm² transversely with respect to the workpiece surface (ref. no.: 1981 RWTH Aachen).

US 2012/0120544 A1 can be named from patent literature as an example in this respect.

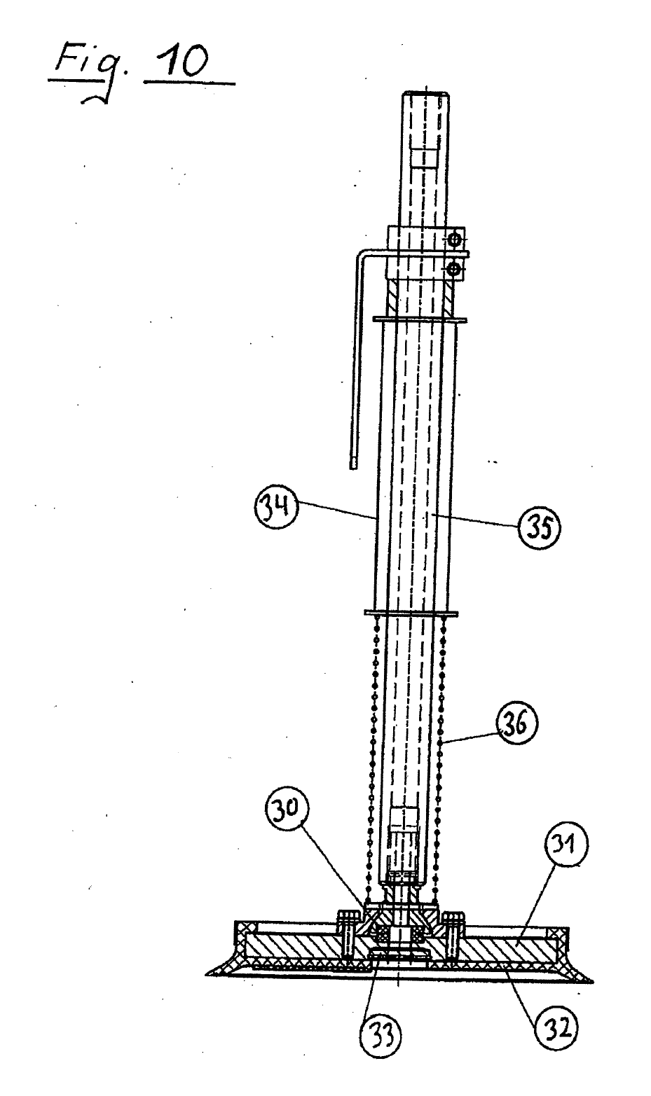

FIG. 10 shows a section through a so-called power suction device as can also be used as holding means 14.

Said type of suction device consists substantially of a suction shaft 35 which is inserted in a guiding and mounting tube 34 and of a suction plate 31 that is fastened thereto. A differential spring 36, which is mounted between the guiding and mounting tube 34 and the suction plate 31, on the one hand takes care of placing the suction plate 31 gently on the plate 5 and on the other hand it supports the flexible suction plate mounting 30 when in an angled position. Said suction plate mounting 30 is produced from a soft, but impact-resisting material and provides a harmonic connection between the suction shaft 35 and the suction plate 31. The circular suction sleeve 32 with its particularly adhesive edge lip provides the actual connection to the plate 5. In its center, the suction plate 31 comprises a circular filter element 33. Said filter element serves the purpose of keeping fine glass particles out of the vacuum pump which is required for operation and is not shown in any detail here. It can either be cleaned manually or exchanged at certain intervals. As a result of a sensor that is not additionally shown, the resistance rate of the filter element 33 of each and every suction device can be detected in a particular expansion level and displayed on a monitor.

In addition, it can be provided that individual suction devices can be switched off individually per se and/or can be acted upon with adjustable negative pressure-air.

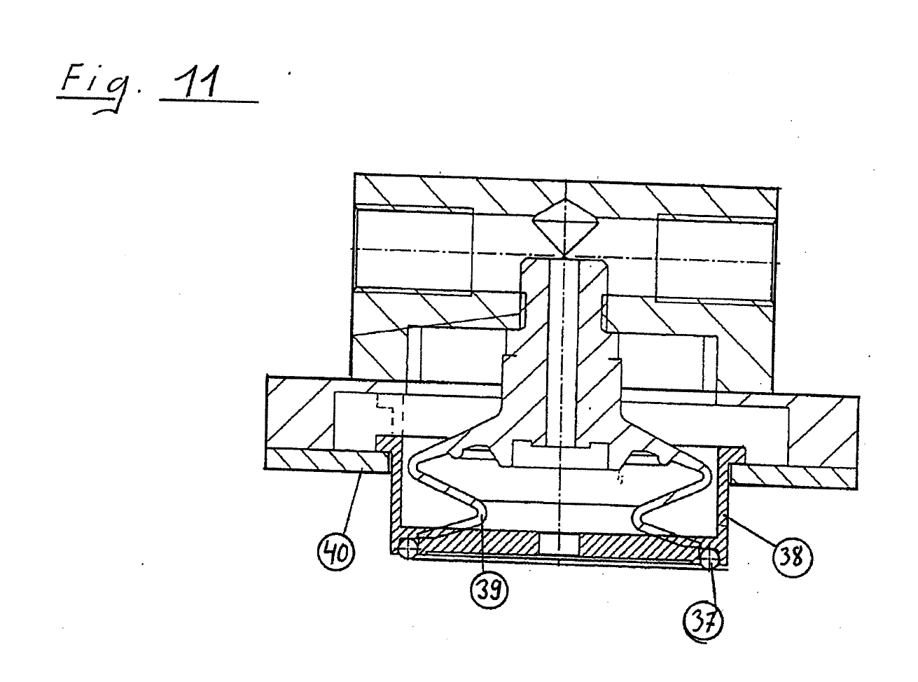

FIG. 11 shows a so-called precision suction device as can also be used as holding means 14.

The special action of said suction device can be seen in said representation. As it is important in the case of glass plates that are to be received that they are conveyed and applied absolutely in a level position, in the case of each suction head the face with which the respective pane is contacted by the respective suction head also has to be absolutely level. This is achieved as a result of a sealing ring 37 that is produced from solid material being guided in a suction head 38 in the representation shown. In this connection, the suction head 38 slides together with a rubber bellows 39 in a holding plate 40. Wave-shaped bending of the received pane at the points of contact with the respective suction device, as is to be feared in the case of other realizations in the prior art with a flexible sealing lip, is ruled out in this connection. The suction head 38, in this connection, can also be approximately square, for example, or can comprise another arbitrary surface form which induces as little mechanical tension as possible in the pane received in each case. Thus, for example, in this context an elliptically formed surface can contribute to reducing the tensions in the respective pane during the receiving and conveying processes.

In addition, it is also possible to use ultrasound suction devices which belong to the prior art.

It must be stressed that naturally two or more apparatuses according to the invention can also work on a conveying device 7 at the same time selecting different kinds of plates 5.

A special control program is required for controlling the complex movement operations and processing the signals of the sensors used.

The invention has been described in detail with particular reference to the preferred embodiment, and variations and modifications may occur to those skilled in the art from the foregoing description and from the appended claims.

1-10. (canceled)

11. An apparatus for quickly transferring glass plates, of different sizes, different thicknesses or different quality levels, one behind another, to different stacking racks, said apparatus having spaciously positioned crane posts with tips, said apparatus comprising:
a) a conveying device in the form of a roller conveyor having conveyor rollers, wherein the conveyor rollers are driven individually and are height-adjustable;
b) a rectangular gripping device having four corners and being provided with rotatable gripping fingers, the gripping fingers being alternately hinged to the left and right-hand side and have holding means arranged thereon, wherein the gripping device is controllably mounted at its four corners by in each case a support cable, the support cables being guided over the tips of spaciously positioned crane posts, and wherein the gripper fingers are able to be shortened in a telescopic-like manner up to almost the total length of the respectively gripper fingers;
c) a diagonal supporting cross for mechanically connecting the crane posts and for mechanically mounting a stabilizing means, the stabilizing means being both extendable in a telescopic-like manner and mechanically connected to the gripping device;
d) a transmitting unit supplying both the electric power required for the gripping device and the control signals required for controlling the gripping device by means of the support cables;
e) a plurality of different types of stacking racks positioned randomly in the region of the crane posts.

12. The apparatus as claimed in claim 11, and further comprising at least one sensor and one light field sensor mounted in the region of the gripping device and at least two light field sensors mounted in the region of the crane posts and the diagonal supporting cross for coordinating the movement operations of the apparatus.

13. The apparatus as claimed in claim 11 wherein the gripper fingers further include at least one of power suction devices and precision suction devices.

14. The apparatus as claimed in claim 11 wherein the glass plates are to be coated, and wherein the apparatus further comprise at least one or both of electrostatic gripping elements and ultrasound grippers turning the respective glass plates on the airside thereof.

15. A method for quickly transferring glass plates of different sizes, different thicknesses or different quality levels one behind another to different stacking racks, said method comprising:
a) capturing the plates using a gripping device suspended on support cables, the gripping device having rotatable gripper fingers provided with holding means and being able to be shortened in a telescope-like manner up to the total length of the respective gripper fingers, and putting the captured plates on a conveyor device with conveyor rollers;
b) adjusting the length of the support cables and conveying the plate with the gripping device to a selected stacking rack, and releasing the holding means and depositing the plate on the selected stacking rack; and
c) conveying the gripping device to its next operating position as a result of the adjustment of the length of the support cables.

16. The method according to claim 15 and further comprising mounting at least one sensor in the region of the gripping device and mounting at least two light field sensors in the region of the crane posts and the diagonal supporting cross for coordinating the movement operations.

17. The method according to claim 16 for coating the glass plates, comprising using at least one or both of electrostatic gripping elements and ultrasound grippers turning the glass plates on the airside.

18. The method according to claim 15 operating at least two of the apparatuses, the apparatuses being defined in claim 11, the method being performed simultaneously on a conveying device for selecting different kinds of plates.
